(19) United States
(12) Patent Application Publication
(10) Pub. No.: US 2008/0142015 A1
(43) Pub. Date: Jun. 19, 2008

(54) Apparatus to provide continuous positive airway pressure

(76) Inventor: David Groll, Murrysville, PA (US)

Correspondence Address: JAMES RAY & ASSOCIATES, 2640 PITCAIRN ROAD, MONROEVILLE, PA, 15146, US

(21) Appl. No.: 12/070,463

(22) Filed: Feb. 19, 2008

Related U.S. Application Data
(63) Continuation-in-part of application No. 11/341,694, filed on Jan. 27, 2006.

(51) Int. Cl. A62B 18/02

(52) U.S. Cl. 128/206.24; 128/206.21

(57) ABSTRACT

Apparatus for communicating a positive fluid pressure to patient's nasal passageways including a mask engaging the area surrounding such patient's nasal passageways, sealing the mask, for delivering breathable gas to patient's air passageways. The mask is manufactured from a composite material with a relatively soft plastic inner layer and a cloth outer layer. The device has an exhaust valve including a plurality of apertures through the composite material. The apparatus includes a retaining means of at least one strap.

### CROSS REFERENCE TO RELATED APPLICATION

This patent application is a continuation in part and claims priority from pending U.S. patent application Ser. No. 11/341,694 filed Jan. 26, 2007.

### FIELD OF THE INVENTION

The present invention relates, in general, to equipment used in the treatment of sleep apnea and other respiratory ailments and, more particularly, the instant invention relates to an apparatus to deliver a fluid pressure to a patient in order to at least one of maintain the patient's airway open while sleeping, deliver oxygen to such patient and a combination thereof.

### BACKGROUND OF THE INVENTION

As is well known in the medical field, sleep apnea is a disorder that commonly affects more than 12 million people in the United States alone. It takes its name from the Greek word apnea, which means “without breath.” People with sleep apnea literally stop breathing repeatedly during their sleep, often for a minute, or longer, and as many as hundreds of times during a single night.

Sleep apnea, as is also known, can be caused by either complete obstruction of the airway (obstructive apnea) or partial obstruction (obstructive hypopnea—hypopnea is slow, shallow breathing), both of which can cause the person suffering from such sleep apnea to wake up.

There are three types of sleep apnea—obstructive, central, and mixed. Of these, obstructive sleep apnea (OSA) is the most common. OSA occurs in approximately 2 percent of women and 4 percent of men over the age of 35.

The exact cause of OSA remains unclear. The site of obstruction in most patients is the soft palate, extending to the region at the base of the tongue. There are no rigid structures, such as cartilage or bone, in this area to hold the airway open. During the day, muscles in the region keep the passage wide open. But as a person with OSA falls asleep, these muscles relax to a point where the airway collapses and becomes obstructed.

When the airway closes, breathing stops and the sleeper awakens to open the airway. The arousal from sleep usually lasts only a few seconds, but brief arousals disrupt continuous sleep and prevent the person from reaching the deep stages of slumber, such as rapid eye movement (REM) sleep, which the body needs in order to rest and replenish its strength. Once normal breathing is restored, the person falls asleep only to repeat the cycle throughout the night.

Typically, the frequency of waking episodes is somewhere between 10 and 60. A person with severe OSA may have more than 100 waking episodes in a single night.

Positive airway pressure has been demonstrated to be a very effective treatment for obstructive sleep apnea. It has three forms: continuous positive airway pressure (CPAP), autotitration and bi-level positive airway pressure (BIPAP). In most cases, positive airway pressure is easier to tolerate at lower pressures. Every patient requires a different pressure. To determine precisely the individual patient's optimum airway pressure, it is necessary to titrate the pressure to each individual patient during a polysomnogram. A polysomnogram will show not only when the respiratory events have ceased, but also when the arousals from the respiratory events occur.

CPAP, the more common of the three therapy modes, usually is administered at bedtime through a facial mask held in place by straps around the patient's head. The mask is connected by a tube to a small air compressor about the size of a shoe box. The CPAP machine sends air under pressure through the tube into the mask, where it imparts positive pressure to the upper airways. This essentially “splints” the upper airway open and keeps it from collapsing.

Approximately 55 percent of patients who use CPAP do so on a nightly basis for more than four hours. It is the most commonly prescribed treatment for OSA. The advantages of CPAP are that it is very safe and completely reversible. Generally, it is quite well tolerated. The main disadvantage is that it requires active participation every night; that is, the patient must put it on for it to work.

All types of positive airway pressure use a mask to deliver the pressure to the patient. Regardless of the method of delivering positive pressure, mask fitting is an essential element of a patient's success with positive airway pressure therapy since it affects compliance and effectiveness of treatment. Higher pressures can result in air leak and patient discomfort. Demands on mask stability increase as pressure increases. Higher pressures may also require tighter head gear to maintain an adequate seal contributing to the discomfort. When selecting a CPAP mask the following factors should be considered.

Comfort

Quality of air seal

Convenience

Quietness

Air venting

Certain side effects of CPAP at least include contact dermatitis, skin breakdown, mouth leaks, nasal congestion, runny nose (rhinorrhea), dry eyes, nose bleeds (rare), tympanic membrane rupture (very rare), chest pain, difficulty exhaling, pneumothorax (very rare), smothering sensation, and excessive swallowing of air (aerophagia).

Nasal congestion often can be reduced or eliminated with nasal steroid sprays and humidification placed into the machine. Rhinorrhea can be eliminated with nasal steroid sprays or ipratroprium bromide nasal sprays. Epistaxis is usually due to dry mucosa and can be combated with humidification. Dry eyes are usually caused by mask leaks and can be eliminated by changing to a better fitting mask.

As discussed above and prior to the conception and development of the present invention, in patients having a sleeping disorder, it has been known in the prior art to use masks that have been located on the patient's face and held in place by a harness formed from straps extending from the mask around the wearer's head and/or neck. In the prior art, the mask is formed using a compliant plastic skin-contacting portion that forms an interface to seal with the patient's skin and provide fluid flow to the patient's airways. This compliant plastic “interface” is supported with some kind of rigid or semi rigid structure that can take the form of a faceplate, cushion support or prong support.

Additionally, such a mask includes some type of “exhalation valve” which serves to exhaust excess flow from the CPAP machine to the atmosphere and to exhaust exhaled CO₂ from the fluid path to prevent the exhaled CO₂ from being rebreathed by the patient.

Normally attached to such mask is a generally hollow tube which is usually independent of the harness. Such hollow tube directs a breathable gas, such as air and/or oxygen, to the wearer.

This arrangement has several disadvantages. First, the cushions are difficult to fit to the patient as each patient has a different facial structure. Poor mask fir leads to air leaks, which diminishes therapy and can cause adverse side effects like dry eyes.

Second, the plastic interface portion is liquid and gas impermeable. This arrangement blocks off the pores of the skin on the portion of the mask which is in contact with the patient. This leads to skin oils collecting between the skin and the interface causing the patient to feel constricted.

Third, the use of a rigid or semi rigid support structure around the face is uncomfortable for the patient. The rigid portions of the mask can press against the patient's face during sleep causing discomfort. Anytime the patient moves, the mask tends to become dislodged.

Fourth, the exhalation valve arrangements normally involve some type of hole or slit in the rigid support structure. This hole results in a jet of air being exhausted from the mask that can cause noise, disturbing the sleep of the patient or their bed partner. Also, this jet of air can blow on the bed partner, further disturbing their sleep.

Additionally, the hollow tube is oftentimes inadvertently pulled by movement of the wearer, particularly during sleep, which may dislodge the mask and adversely affect gas delivery to the patient's airways, thereby significantly reducing the effectiveness of the treatment.

Another important disadvantage is that the mask, straps and hollow tube are prone to entanglement, which increases the difficulty of correctly installing the mask and harness.

Finally, a further disadvantage is that the patient often must use a chinstrap to keep the mouth closed during use. This prevents leaking of the positive airway pressure from the mouth but makes the use of CPAP therapy more cumbersome for the patient.

The present invention seeks to overcome or at least ameliorate these problems associated with the prior art type devices.

### SUMMARY OF THE INVENTION

In a presently preferred embodiment, the present invention provides an apparatus for communicating a fluid pressure to a patient's nasal passageways or air passageways disposed in fluid communication with a patient's mouth to at least one of alleviate sleep apnea symptoms and provide oxygen to patients suffering from an affliction requiring such oxygen. This apparatus includes a mask having each of a first open end and a second open end. The first open end of such first means being disposed for communicating at least one of air, oxygen and a combination of air and oxygen to such patient's nasal passageways or air passageways disposed in fluid communication with such patient's mouth. Air would be supplied for example to patients suffering from sleep apnea and oxygen to patients suffering from various lung ailments. A first open end of such mask is engageable with at least a portion of an area adjacent such patient's nasal air passageways disposed in fluid communication with a patient's mouth. There is a positive air pressure communication means engageable with the second open end of such mask for communicating the at least one of such air, oxygen and a combination of air and oxygen to the second open end of such mask. The mask is manufactured of a composite material with an impermeable to fluid inner layer and a flexible compliant outer layer. In operation, the fluid communication means and mask inflates engaging the first open end of the mask with the area adjacent to the patient's nasal passageways. The preferred embodiment has a soft plastic inner layer and a cloth outer layer.

Further, there is a means disposed on the apparatus which is engageable with a portion of the mask a predetermined distance from the first open end of such mask for retaining the first open end of such mask in at least a portion of an area adjacent such patient's air passageways disposed in fluid communication with a patient's mouth. Preferably the means is at least one strap and preferably an adjustment means to fit the apparatus to various size heads. The adjustment means is preferably a hook and loop arrangement. The preferred embodiment has at least two adjustable straps, at least one strap in the horizontal axis and at least one strap in the vertical axis to provide a snug fit for the patient.

The final essential element of the apparatus of the present invention is an exhalation valve disposed on the apparatus a predetermined spacing from such sealing means for exhausting CO₂ being exhaled from such patient and overflow of fluid to the atmosphere. The exhaust valve is a plurality of apertures in the mask or positive pressure communication means.

Preferably, the fluid communication means has a connector to connect the fluid communication means to a positive pressure supply such as a tank or pump.

Preferably, a soft material such as the outer layer of the composite material covers at least a portion of the first open end of the mask that is in contact with the patient's face to provide a comfortable fit for the patient. The soft material may be attached separately to inner and outer surface of the mask generally adjacent to the contact surface at the first open end of the mask or by extending the outer layer of the composite material and attaching the extended outer layer to the inner surface generally adjacent to the first open end of the mask. A substantial portion of the first open end of the mask may be covered with the soft material as described above.

### OBJECTS OF THE INVENTION

It is, therefore, one of the primary objects of the present invention to provide an apparatus for communicating a positive fluid pressure to a patient's nasal and/or air passageways which is less likely to become dislodged during use.

Another object of the present invention is to provide an apparatus for communicating a positive fluid pressure to a patient's nasal and/or air passageways that is less likely to become tangled during use.

Still another object of the present invention is to provide an apparatus for communicating a positive fluid pressure to a patient's nasal and/or air passageways that is more comfortable for the patient.

Yet another object of the present invention is to provide an apparatus for communicating a positive fluid pressure to a patient's nasal and/or air passageways having substantially improved air sealing capability.

A further object of the present invention is to provide an apparatus for communicating a positive fluid pressure to a patient's nasal air passageways which is generally more convenient than prior art type mask.

An additional object of the present invention is to provide an apparatus for communicating a positive fluid pressure to a patient's nasal and/or air passageways that is relatively quiet during operation.

Still yet another object of the present invention is to provide an apparatus for communicating a positive fluid pressure to a patient's nasal and/or air passageways having improved air-venting capability.

Yet still another object of the present invention is to provide an apparatus for communicating a positive fluid pressure to a patient's nasal and/or air passageways substantially all portions of such apparatus that touches a patient's face are made of composite material.

Another object is to provide a plurality of apertures that acts as an exhalation valve and diffuse outflow from the mask.

A still further object of the present invention is to provide an apparatus for communicating a positive fluid pressure to a patient's nasal and/or air passageways wherein said apparatus is substantially capable of conforming to a patient's facial features.

Another object of the present invention is to provide an apparatus for communicating a positive fluid pressure to a patient's nasal and/or air passageways in which there are substantially no moisture-impermeable surfaces in contact with a patient's skin.

Yet another object of the present invention is to provide an apparatus for communicating a positive fluid pressure to a patient's nasal and/or air passageways in which there are no rigid parts to press against the patient's skin while the patient sleeps.

In addition to the various objects and advantages of the present invention which have been described above, various other objects and advantages of the invention will become more readily apparent to those persons skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the presently preferred embodiment of the invention.

FIG. 2 is a cross section view along line A-A in FIG. 1.

FIG. 3 is a perspective view of another embodiment of the invention.

### BRIEF DESCRIPTION OF A PRESENTLY PREFERRED AND VARIOUS ALTERNATIVE EMBODIMENTS OF THE PRESENT INVENTION

Prior to proceeding to the more detailed description of the instant invention it should be noted that identical components having identical functions have been designated with identical reference numerals throughout the several views illustrated in the drawings for the sake of clarity.

As used in the present specification and claims the term composite is meant to include at least 2 layers. The interior layer is relatively is impermeable to gas and is soft so that it does not press a rigid surface against the patient and the exterior layer is cloth. The preferred embodiment of the inner layer is a soft plastic.

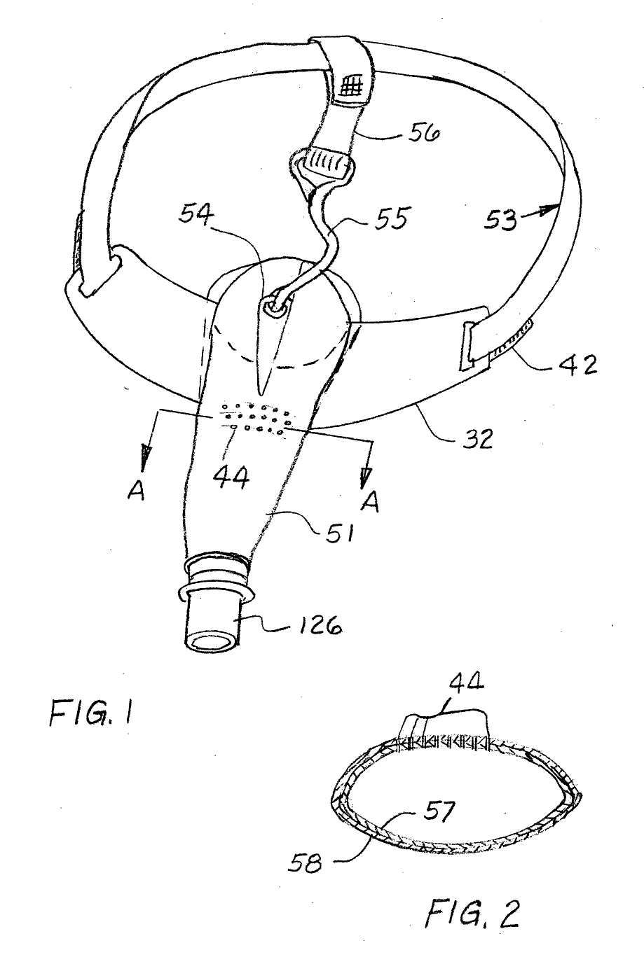

Now refer more particularly to FIG. 1. Illustrated therein is are the presently preferred embodiments of an apparatus, generally designated 10, for communicating a positive fluid pressure to a patient's nasal passageways (not shown) to at least one of alleviate sleep apnea symptoms and provide oxygen to patients suffering from an affliction requiring such oxygen.

FIG. 1 shows the presently preferred embodiment wherein a mask is preferably manufactured of a composite material, previously described, and the mask seals the area generally surrounding the patient's nasal passageways.

Additionally, it can be noted here that it is presently preferred for the balance of the entire apparatus be made substantially from the composite material thereby making the apparatus compliant.

The mask has a first open end adjacent to said user's face and a second open end. In FIG. 1, the first open end of said mask is engageable with at least a portion of user's face adjacent user's nose for substantially sealing the mask to user's face. At least a portion of the first open end of the mask has soft material covering end of the inner layer. The preferred embodiment is to that such soft material is the cloth outer layer. In the preferred embodiment, the cloth outer layer extends beyond the plastic inner layer and attached to the inner surface of the plastic inner layer. At least a portion of the contact surface of the first open end of mask 10 with such user's face is the cloth outer layer providing a more comfortable fit for such user. The entire contact surface of the first open end of mask 10 may be cloth.

A fluid communications means 51 is engageable at the said second open end of the mask for communicating positive air pressure. The fluid communications means 51 is preferably manufactured of the composite material.

An exhaust valve is positioned on the mask or fluid communication means 51. In the preferred embodiment, the exhaust valve is a plurality of apertures 44 of predetermined size through the composite material to dispose of excess communicated fluid flow and exhaled gases from within the apparatus. In the preferred embodiment the apertures are 0.005 inches in diameter. Such gases are exhausted through the apertures 44 through the composite material. The plurality of apertures provides a generally quieter less distracting sleeping environment by diffusing the outflow as well as exhausting the exhaled gases.

FIG. 2 is a cross section through line A-A of FIG. 1. The figure illustrates the composite material with an inner layer 57 preferably of soft plastic and preferable outer layer of cloth 58. Apertures 44 are illustrated. The exhalation valve can be located on either the mask, the fluid communication means 51 as shown if FIG. 1 or on both.

The mask, the fluid communication means 51 is preferably integral with the mask. The fluid communications means 51 is preferably attached to air tube 126 to supply a breathable gas communicating positive air pressure to the patient. The air tube 126 could be attached directly to the mask.

The final essential element of the apparatus is a means, disposed on such mask and engageable with the fluid communications means 51 for retaining the mask in position on such patient's face during use. Such retaining means during use is at least one strap 32. At least one strap 32 is preferably formed integrally with mask as a single piece formed from elastometric cloth. The strap 32 may also be attached to at least one side of the mask. Strap 32 includes an adjustment means on the strap 32, for fitting a different size heads of various patients.

Such adjustment means can be selected from the group consisting of a hook and loop type fastener and a tie type fastener. According to the presently preferred embodiment of the invention the adjustment means will be a hook and loop type fastener 42 at the end of such at least one strap 32.

The preferred embodiment straps 32 have a first end and a second end. The first ends of straps 32 are preferably affixed to opposing sides of the mask. Straps 32 have a slot at a predetermined distance from the second end. A second strap 53 has adjusters 42 as previously described at opposing ends. Second strap ends are threaded through the slots in straps 32. Flap 59 is attached to the top of the mask. Flap 59 has an aperture. An elastic band 55 has a first end and a second end. The first end of the elastic band 55 is threaded through the aperture in flap 59 and attached to the elastic band 55 forming a closed loop. A third strap 56 has a first end and a second end. The first end of the third strap 56 is attached to itself forming a loop. The second end of the elastic band 55 is threaded through the first end loop of the third strap 56 and attached to itself for form a closed loop. The second end of the third strap 56 has an adjuster 42 and is looped around and slidably attached to the second strap 53. Thus the user can adjust the apparatus horizontally and vertically to assure a snug fit.

In the presently preferred embodiment of the invention when it is being used for sleep apnea the pump means will be used and when oxygen is called for a tank means, such as an oxygen tank, having a connection to the fluid communication means 51 will be preferred.

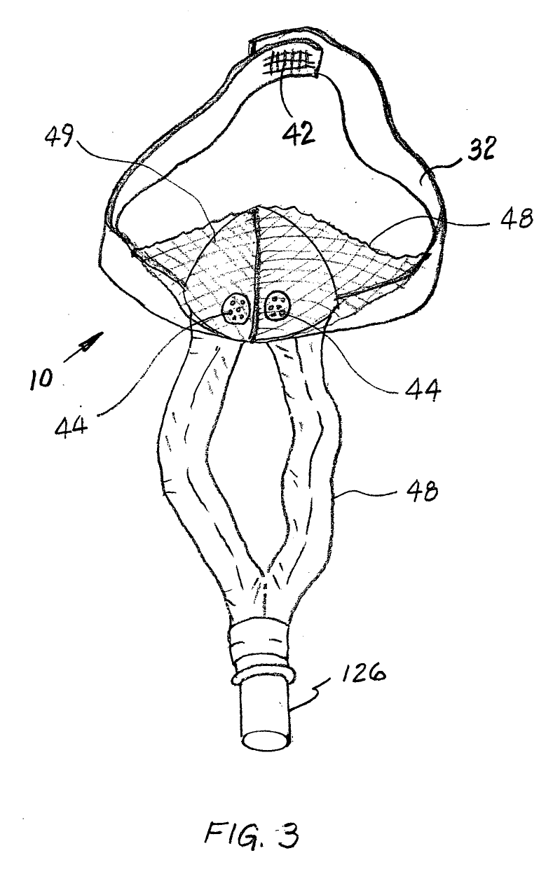

FIG. 3 shows an alternative embodiment wherein a mask 46 is preferably manufactured of a composite material, previously described and seals the area surrounding both of the patient's nasal passageways. The fluid communications means 51 is preferably manufactured of the composite material. The fluid communication means 51 is preferably integral with the mask. The fluid communications means 51 is preferably attached to air tube 126 to supply a breathable gas communicating positive air pressure to the patient. The air tube 126 could be attached directly to the mask.

In the alternative embodiment as shown in FIG. 3, the positive fluid pressure communication means 51 is at least 2 tubes. The tubes are connected to a Y type connector to connect the apparatus to a positive fluid pressure source. The alternative embodiment also includes a separator to separate sealing each nostril of user separately.

FIGS. 1 and 3, such positive fluid pressure can be communicated from such one of a pump means and a tank means to the fluid communication means. Referring to FIG. 3 it can be seen that such positive fluid pressure can also be communicated from such one of a pump means and a tank means to such fluid communication means adjacent a chest of such patient and such apparatus 10 will further include a connector 126 between a source of such fluid pressure and said fluid communication means 51.

FIG. 3 illustrates another embodiment, preferably manufactured from the composite material, as previously described. The mask engages the patients face with the interior layer of the mask 46 in contact with patient sealing each nasal passageway and adjacent area separately. The air tube 126 is attached to the fluid communications means. The exhaust valve has a plurality of apertures 44 through the composite material. A material preferably cloth or mesh 47 is attached to the mask 48 and the strap 32 for securing the device to the patient's head. The adjusting means is preferably a hook and loop type fastener. The preferred embodiment uses a Y type tube 48 preferably manufactured from the composite material previously described and attached to mask 46. Air tube 126 connected to a supply communicating positive air pressure to the patient. The apparatus is held in place with strap 32 attached to the mask and is adjustable. The adjuster is a hook and loop type fastener 42 or a tie. These adjusters are applicable to both embodiments. An additional mesh or cloth layer is attached to the mask and strap to further secure the mask to the patient's face.

While in accordance with the patent statutes the presently preferred and various alternative embodiments of the instant invention have been described in detail above, it should be understood that various other modifications and alternatives can be envisioned by those persons skilled in the art without departing from either the spirit of the invention or the scope of the appended claims.

I claim:

1. An apparatus for communicating a breathable gas with positive pressure to a patient's air passageways to alleviate sleep apnea symptoms, said apparatus comprising:
(a) a mask manufactured from a composite material having a cloth outer portion and a soft plastic inner portion and having each of a first open end and a second open end, said first open end of said mask being disposed for communicating said positive fluid pressure to such patient's air passageways, said soft plastic inner portion of said mask engageable with at least a portion of an area generally adjacent to such patient's pair of nasal passageways for sealing said mask to said area;
(b) at least one fluid communication means for communicating such positive air pressure to said second open end of said mask;
(c) a means disposed on said mask for retaining said first open end of said mask in said area adjacent such patient's pair of nasal passageways during use; and
(d) a plurality of apertures through said composite material to serve as an exhalation valve for exhausting gas to the atmosphere.

2. An apparatus, according to claim 2, wherein said positive fluid communication means is formed from a composite material having a cloth outer portion and a soft plastic inner portion.

3. An apparatus, according to claim 1, wherein said fluid communication means engageable with said second open end of said mask is tubing.

4. An apparatus, according to claim 1, wherein a connector is attached between such source of positive air pressure and said fluid communication means.

5. An apparatus, according to claim 1 wherein said apertures are about 0.005 inches in diameter.

6. An apparatus, according to claim 1 wherein the apertures are disposed on said mask.

7. An apparatus, according to claim 2 wherein the apertures are disposed on said fluid communication means.

8. An apparatus, according to claim 2 wherein the apertures are disposed on said fluid communication means and said mask.

9. An apparatus, according to claim 1 wherein at least a portion of said first open end of said mask has a soft material covering the interior layer of said composite material attached to the interior layer and exterior layer of said composite material of said mask.

10. An apparatus according to claim 9 wherein substantially all of said first open end of said mask is covered with said outer layer of said composite material.

11. An apparatus, according to claim 1 wherein at said first open end of said mask said outer layer extends beyond said inner layer of said composite material so that at least a portion of said first open end of said mask said outer layer of said composite material covers the end of said inner layer of said composite material at said first open end of said mask and said extended outer layer of said composite material is attached to the interior surface of said inner layer of said composite material of said mask.

12. An apparatus according to claim 11 wherein substantially all of said first open end of said mask is covered with said outer layer of said composite material.

13. An apparatus according to claim 1 wherein said mask further has dividing member so that said mask separately seals each nasal passageway and further having at least two fluid pressure communications means.

14. An apparatus according to claim 13 wherein a said mask includes a pliable member to further secure said mask on patient's face.

15. An apparatus according to claim 13 wherein a Y connector is placed between such source of positive fluid pressure and said at least two fluid communications means.

16. An apparatus, according to claim 1, wherein said means disposed on said mask and engageable with said fluid communication means for retaining said mask in position in during use is at least one strap.

17. An apparatus, according to claim 16, wherein said at least one strap is formed integrally with said apparatus as a single piece formed from a composite material having a cloth outer portion and a soft plastic inner portion.

18. An apparatus, according to claim 16, wherein said at least one strap includes an adjustment means for fitting different size heads of various patients.

19. An apparatus, according to claim 16, wherein said adjustment means is selected from the group consisting of a hook and loop type fastener and a tie type fastener.

20. An apparatus according to claim 16 wherein said retaining means further includes at least a second strap, said first strap having a top edge a first end and a second end and a second strap having a first end and a second end wherein said first strap first and second ends attach to said side of said mask and said first end of said second strap attaches to said top of said mask and said second end slidably attaches to said first strap at the back of user's head.

21. An apparatus according to claim 16 wherein said at least first and second straps have an adjusting means.
